(19) United States
(12) Patent Application Publication
(10) Pub. No.: US 2008/0088572 A1
(43) Pub. Date: Apr. 17, 2008

(54) Method for controlling luminance of divided block backlight of liquid crystal display

(76) Inventors: Te-Mei Wang, Hsin-Chu (TW); Po-Jen Tsai, Hsin-Chu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/826,444

(22) Filed: Jul. 16, 2007

(30) Foreign Application Priority Data
Oct. 17, 2006 (TW) 095138246

(51) Int. Cl. G09G 3/36

(52) U.S. Cl. 345/102

(57) ABSTRACT

A method for controlling luminance of divided backlight block of a liquid crystal display(LCD) includes the steps of: inputting an image; dividing the image into a plurality of blocks according to the backlight blocks; obtaining a weighted color value of each pixel by performing a weighted operation on a maximum color value of each pixel; and accumulating the weighted color values of the pixels in each block, then dividing the accumulated value by the number of the pixels in each block to get an averaged weighting value of luminance of each block. The method further includes a step of establishing a look up table stored the relationship of the plurality of the color values of the pixels and the plurality of weighted color values corresponding to the color values. The method can control the luminance of each divided backlight block of the LCD.

### FIELD OF THE INVENTION

The invention relates to a method for controlling luminance of liquid crystal display(LCD), and in particular, to a method for controlling luminance of a divided backlight block of LCD to control luminance of the image displayed in a liquid crystal display.

### RELATED ART

The contrast ratio is an important factor for the quality of the images displayed in a liquid crystal display (LCD). However, if a signal of a dark image is inputted to an LCD, the dark image displayed in the LCD will be not dark enough due to the light leakage of the LCD. Generally, the contrast ratio of LCD TV is about 10³ worse than the conventional CRT or PDP TVs.

In order to improve the deficiency of the contrast ratio, a High Dynamic Contrast LCD System has been employed in the LCD. The system utilizes a backlight module installed with light-emitting diodes (LEDs) to improve the contrast ratio of the LCD better than 10⁴. Depending on the cost for mass production, the LED backlight is divided into a plurality of blocks in a number of n*m. Luminance of each backlight block can be controlled independently. One of the easy ways to control the luminance of each backlight block is based on an average value of the luminance of corresponding image block. The way to get the average value of luminance of each block is getting maximum color values of the plurality of pixels in each block, accumulating the plurality of maximum color values of each block, and dividing the accumulated value by the number of pixels in each block. The formula used to get the average value of luminance is represented as

$${L}_{block} = \frac{{\sum }_{i = 1}^{n} max ( {R}_{i} , {G}_{i} , {B}_{i} )}{n} , \qquad ( 1 )$$

where max(R,G,B) and n represent the maximum color value of each pixel and the number of the pixels corresponding to each backlight block, respectively.

The above-mentioned way to get the average value can make the backlight of the LCD stably and prevent the interference of the noise signal. However, the LCD having such backlight module fails to display the details of the darker images so that the image quality of the LCD is undesirable.

In view of foregoing, the invention is to provide a method for controlling luminance of the divided backlight blocks of the image achieving the objects of improving the LCD displaying the details of the darker images, and enhancing the contract ratio of the images displayed in the LCD. The method is also for controlling luminance of the LED installed in the backlight module of the LCD to stabilize the backlight and to prevent the interference of the noise signal.

### SUMMARY OF THE INVENTION

Accordingly, it is an object of the present invention to provide a method for controlling luminance of the divided backlight blocks of LCD to improve the contrast ratio of the images displayed in an LCD.

Another object of the present invention is to provide a method for controlling luminance of the divided backlight blocks of LCD to enhance the image quality of the LCD during displaying the darker images.

Another object of the present invention is to provide a method for controlling the luminance of the LED installed in the backlight module of the LCD to stabilize the backlight and to prevent the interference of the noise signal.

Yet another object of the present invention is to provide a method for enhancing the luminance of the divided backlight blocks of the image. The method further comprises a step of establishing a look up table. The enhanced luminance of each divided backlight block can be obtained quickly based on the look up table. The advantages of establishing the look up table is to simplify the steps of the backlight luminance enhancement method, to reduce the processing time, and to improve the processing speed for controlling the divided backlight blocks of the image.

In order to achieve the above objects, the present invention provides a method for controlling luminance of the divided backlight blocks of the image comprising the steps of inputting an image to an LCD; dividing the image into a plurality of blocks according to the backlight blocks, in which each block has a plurality of pixels; obtaining a weighted color value of each pixel by performing a weighted operation on a maximum color value of each pixel; accumulating the plurality of weighted color values of the pixels in each block, then dividing the accumulated value by the number of the pixels in each block to get an averaged weighting value of luminance of each block. Luminance of each backlight block can be controlled based on the averaged weighting value of luminance.

In order to achieve the above objects, the present invention provides a method for controlling luminance of the divided backlight blocks of the image further comprises a step of establishing a look up table according to the plurality of the maximum color values and the plurality of weighted color values corresponding to the maximum color values. The look up table can be established in an LCD for enhancing luminance of each backlight block of the displayed image so that the details of the darker images can be seen.

### BRIEF DESCRIPTION OF THE DRAWINGS

The invention will become more fully understood from the detailed description given herein below illustration only, and thus is not limitative of the present invention, where:

FIG. 1 shows a basic flow diagram of the present invention;

FIG. 2 shows a look up table according to one preferred embodiment of the present invention;

FIG. 3 shows a relationship between the color values and the weighted color values according to another embodiment of the present invention; and

FIG. 4 shows a flow diagram according to another embodiment of the present invention.

### DETAILED DESCRIPTION OF THE INVENTION

The present invention will be apparent from the following detailed description, which proceeds with reference to the accompanying drawings.

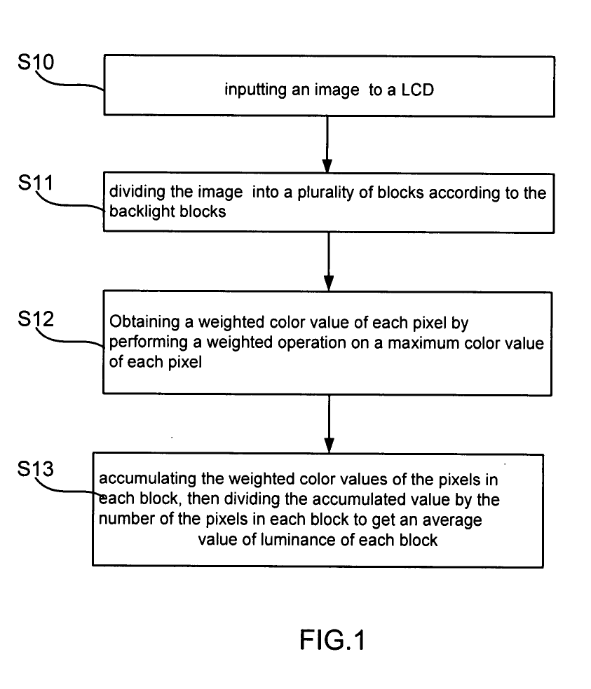

FIG. 1 shows a basic flow diagram of the present invention. As shown in FIG. 1, the method for controlling luminance of a divided backlight block of an image executes the step of S10 first: inputting an image to an LCD. Subsequently, the method executes the step of S11: dividing the image into a plurality of blocks according to the backlight blocks, in which each block has a plurality of pixels and each pixel has a maximum color value. Furthermore, the method executes the step of S12: obtaining a weighted color value of each pixel by performing a weighted operation on the maximum color value of each pixel. In the step of S12, performing a weighted operation on the maximum color value is multiplying by a weighting coefficient. The weighting coefficient is a multiple or power. The weighting coefficient may also be obtained from the luminance of the backlight of the LCD and/or a transmittance of liquid crystal of the LCD. The weighted color value can be obtained by performing a weighted operation on the maximum color value. Finally, the method executes the step of S13: accumulating the weighted color values of the pixels in each block, then dividing the accumulated value by the number of the pixels in each block to get an averaged weighting value of luminance of each block. The method of the present invention controls luminance of each backlight block according to the averaged weighting value of luminance corresponding to each corresponding image block. The formula to get the averaged weighting value of luminance of each block is represented as

$${L}_{block} = \frac{{\sum }_{i = 1}^{n} f [ max ( {R}_{i} , {G}_{i} , {B}_{i} ) ]}{n} \qquad ( 2 )$$

where max(R,G,B) represents the maximum color value of each pixel;
f represents the weighting coefficient;
f[max(R,G,B)] represents the weighted color value performing a weighted operation on the maximum color value of each pixel; and
n represents the number of the pixels in each block.

According to the step of S12, the image is divided into the plurality of blocks according to the backlight blocks and each block has the plurality of pixels. The color value of each pixel is in a range of 0 to 255 and includes a red color value (R), a green color value (G), and a blue color (B). The maximum color value of the pixel is obtained from a maximum value of the red color value, the green color value, and the blue color value included in the color value of the pixel. For example, if the red color value, the green color value, and the blue color value are 216, 134 and 18, respectively, the maximum color value of the pixel is 216. The maximum color value of each pixel can be obtained by this way. After executing the steps of S12 and S13, the enhanced luminance value of each block can be obtained.

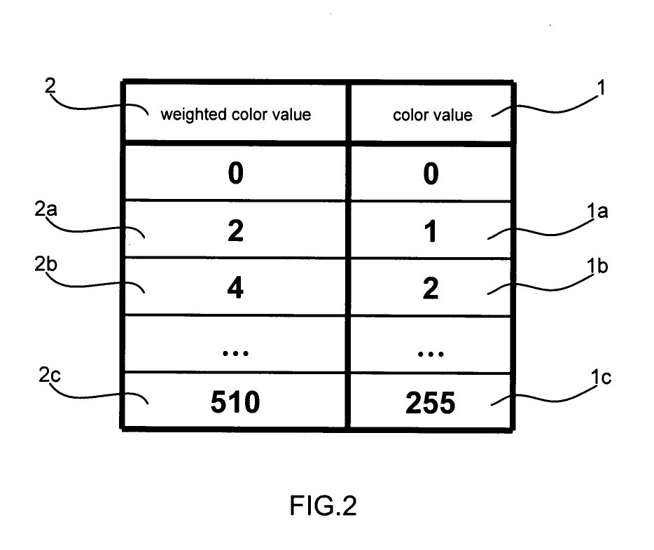

Yet referring to FIG. 2, after executed the steps of S11 to S13, a look up table is established according to the plurality of maximum color values and the plurality of the weighted color values corresponding to the maximum color values. The look up table includes the plurality of color values 1 and the plurality of weighted color values 2 corresponding to the maximum color values. FIG. 2 shows a look up table of one preferred embodiment of the present invention. As shown in FIG. 2, when the color values 1a, 1b, 1c represent as the values of 1, 2, 255, the weighted color values 2a, 2b, 2c represent as 2, 4, 510, respectively. The color values 1 is in a range of 0 to 255. Furthermore, the weighted color values 2 are obtained from the color values 1 multiplying by the weighting coefficient so that the weighting coefficient is a multiple and is a value of 2. The weighting coefficient can also be a power or be obtained from the luminance of the backlight of the LCD and/or a transmittance of a liquid crystal of the LCD.

The look up table can be stored in the LCD after established. When an image inputted to the LCD, the luminance value of each divided backlight block of the image can be obtained according to the look up table so that operation speed of controlling each backlight block can be enhanced.

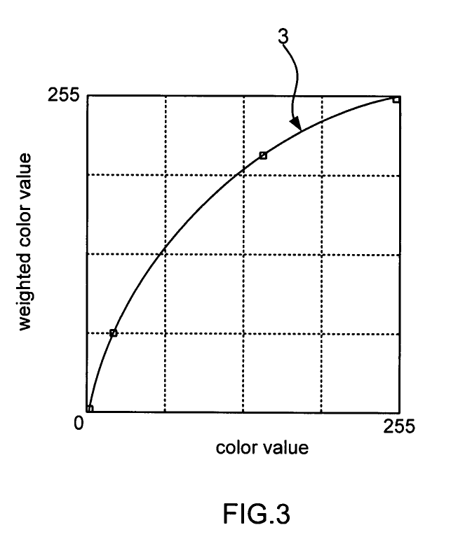

FIG. 3 shows a relationship between the color values and the weighted color values according to another embodiment of the present invention. As shown in FIG. 3, the relationship curve 3 represents the relationship between the color values and the weighted color values. The color values are in a range of 0 to 255 and the weighted color values are products of the color values multiplying by the weighting coefficient according to the relationship curve 3. The weighting coefficient is not only a multiple but is also a power or obtained from the luminance of the backlight of the LCD and/or a transmittance of the liquid crystal of the LCD. The look up table can be established according to the relationship curve 3 and stored in the LCD. The LCD can control luminance of the image by the averaged weighting value of luminance of each backlight block according to the look up table to achieve the object for enhancing luminance of the divided backlight block of the image.

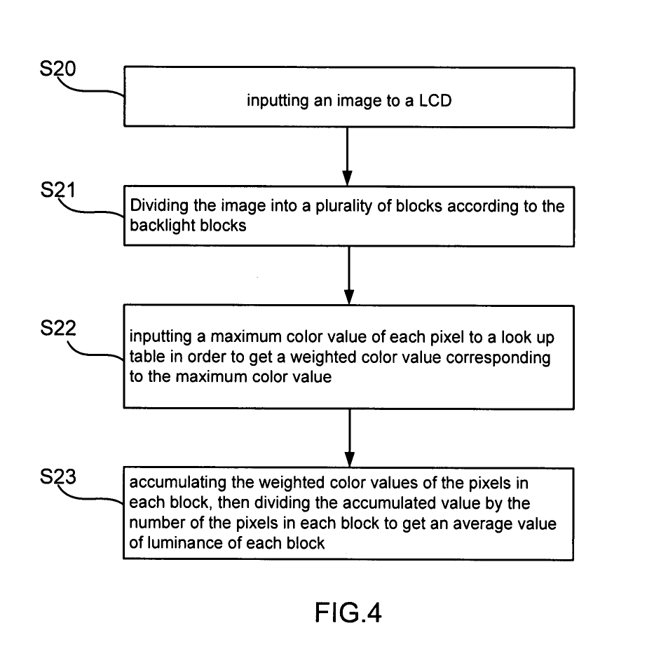

FIG. 4 shows a flow diagram according to another embodiment of the present invention. As shown in FIG. 4, the method for controlling luminance of a divided backlight block of an image executes the step of S20 first: inputting an image to an LCD. Continuously the method executes the step of S21: dividing the image into a plurality of blocks according to the backlight blocks, in which each block has a plurality of pixels and each pixel has a maximum color value. Furthermore the method executes the step of S22: obtaining a weighted color value of each pixel by inputting the maximum color value to a look up table which stored the relationship of the plurality of color values and the plurality of weighted color values corresponding to the color values. Finally, the method executes the step of S23: accumulating the weighted color values of the pixels in each block, then dividing the accumulated value by the number of the pixels in each block to get an averaged weighting value of luminance of each block. The method of the present invention enhances the luminance of each backlight block according to the averaged weighting value of luminance corresponding to each block. In another embodiment of the present invention, the luminance value of each backlight block is obtained from the look up table to simplify the steps of the method, to reduce the processing time, and to improve the processing speed for controlling the divided backlight blocks of the image.

As mentioned above, the method for controlling luminance of the divided backlight blocks of the image achieve the advantages of: enhancing the contrast ratio of the image displayed in the LCD, improving the image quality of the LCD when displaying a darker image, controlling luminance of the LED installed in the backlight of the LCD, and preventing the interference of the noise signal to make the backlight stably. Furthermore, the method of the present invention includes the step of establishing a look up table to simplify the steps of the method, to reduce the processing time, and to improve the processing speed for controlling the divided backlight blocks of the image.

While the invention is susceptible to various modifications and alternative forms, specific embodiments thereof have been shown by the way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention ad defined by the appended claims.

What is claimed is:

1. A method for controlling luminance of a divided backlight block of a liquid crystal display (LCD), comprising:
inputting an image;
dividing the image into a plurality of blocks, in which each block has a plurality of pixels;
obtaining a weighted color value of each pixel by performing a weighted operation on a maximum color value of each pixel; and
accumulating the weighted color values of the pixels in each block, and dividing the accumulated value by the number of the pixels in each block to get an averaged weighting value of luminance of each block.

2. The method as claimed in claim 1, wherein the color value includes a red color value, a green color value, and a blue color value.

3. The method as claimed in claim 1, wherein the maximum color value is a maximum value of the color values of each pixel.

4. The method as claimed in claim 1, wherein the maximum color value is in a range of 0 to 255.

5. The method as claimed in claim 1, wherein performing a weighted operation on the maximum color value comprises multiplying by a weighted coefficient.

6. The method as claimed in claim 5, wherein the weighted coefficient is a multiple.

7. The method as claimed in claim 5, wherein the weighted coefficient is a power.

8. The method as claimed in claim 5, wherein the weighted coefficient is obtained from a luminance of a backlight or a transmittance of liquid crystal of the LCD.

9. The method as claimed in claim 1, further comprising establishing a look up table according to the plurality of maximum color values and the plurality of weighted color values corresponding to the maximum color values, wherein the look up table stores the plurality of color values and the plurality of weighted color values corresponding to the color values.

10. The method as claimed in claim 9, wherein the color value is in a range of 0 to 255.

11. The method as claimed in claim 9, wherein the weighted color value corresponds to a product of the color value multiplied by a weighting coefficient.

12. The method as claimed in claim 9, wherein the look up table is established in an LCD so that the LCD can control the luminance of each backlight block of the image according to the look up table.

13. A method for controlling luminance of a divided backlight block of a liquid crystal display (LCD) comprising:
inputting an image;
dividing the image into a plurality of blocks, in which each block has a plurality of pixels;
inputting a maximum color value of each pixel to a look up table to get a weighted color value corresponding to the maximum color value;
accumulating the weighted color values of the pixels in each block, then dividing the accumulated value by the number of the pixels in each block to get an averaged weighting value of luminance of each block.

14. The method as claimed in claim 13, wherein the color value includes a red color value, a green color value, and a blue color value.

15. The method as claimed in claim 13, wherein the maximum color value is a maximum value of the color values of each pixel.

16. The method as claimed in claim 15, wherein the maximum color value is in a range of 0 to 255.

17. The method as claimed in claim 13, wherein the look up table stores the plurality of color values and the plurality of weighted color values corresponding to the color values.

18. The method as claimed in claim 13, wherein the color value is in a range of 0 to 255.

19. The method as claimed in claim 13, wherein the weighted color value corresponds to a product of the color value multiplied by a weighting coefficient.

20. The method as claimed in claim 19, wherein the weighted coefficient is a multiple.

21. The method as claimed in claim 19, wherein the weighted coefficient is a power.

22. The method as claimed in claim 19, wherein the weighted coefficient is obtained from a luminance of a backlight or a transmittance of liquid crystal of the LCD.
